(19) United States
(12) Patent Application Publication
(10) Pub. No.: US 2002/0122553 A1
(43) Pub. Date: Sep. 5, 2002

(54) Method and apparatus for lightweight rekeying of a master key in a single sign-on system

(75) Inventors: I-Lung Kao, Austin, TX (US); George Conerly Wilson, Austin, TX (US)

Correspondence Address: Joseph R. Burwell, Law Office of Joseph R. Burwell, P.O. Box 28022, Austin, TX, 78755-8022, US

(73) Assignee: International Business Machines Corporation, Armonk, NY (US)

(21) Appl. No.: 09/798,298

(22) Filed: Mar. 1, 2001

(51) Int. Cl. H04L 9/00

(52) U.S. Cl. 380/28

(57) ABSTRACT

A method, system, apparatus, and computer program product are presented for significantly decreasing the computational effort for a rekeying process without sacrificing the security of a single sign-on system. For each user, a “minor” key is created when the user's account within the single sign-on system is created; the user's minor key is used to encrypt and decrypt the user's target passwords. However, to protect the confidentiality of a user's minor key, the minor key is not stored directly. Instead, a storage key is generated by masking a user's minor key with the master key in an appropriate manner, e.g., using the user's minor key and the master key as inputs to an exclusive-OR function to generate the storage key. A user's storage key can then be stored without compromising the user's minor key or the master key, and the user's minor key can be efficiently regenerated using the storage key and the master key.

### BACKGROUND OF THE INVENTION

1. Field of the Invention

The present invention relates to an improved data processing system and, in particular, to a method and system for network administration. Still more particularly, the present invention provides a method and system for managing passwords.

2. Description of Related Art

In virtually every networking system, an administrative system secures resources by restricting access to those resources, which requires authentication of a user when the user wants to access a restricted resource. A large network within an enterprise may have many types of resources to be accessed: physical resources, such as client machines; and logical resources, such as computer programs. Each resource may have its own authentication scheme in which each user is assigned a username and password. Rather than inefficiently requiring users to remember numerous, independent usernames and passwords, centralized authentication systems have been developed.

In a centralized authentication system, the user is required to sign-on once, and the user is provided with access to restricted resources based on credentials stored on a global server. Whenever a secure resource is accessed, the credentials are retrieved from the database on the global server and provided to the secure resource to authenticate the user. This generally occurs in the background without the need for any intervention by the user and is usually termed a “single sign-on” (SSO) system.

One example of an SSO system provides centralized password management for all the users in an enterprise. The passwords of all SSO users for various SSO targets are stored/managed in a centralized SSO database. This database is preferably structured as a security registry according to the Open Software Foundation's (OSF) Distributed Computing Environment (DCE) standard. Since a DCE security registry does not provide any encryption facility for applications to protect the confidentiality of the data stored in the registry, the SSO server uses a “master key” to encrypt all of the target passwords before storing them in the SSO database. When the target passwords of an SSO user are retrieved by the SSO server, at the request of a SSO client (running on behalf of the SSO user), the passwords will be decrypted with the same master key before being sent to the SSO client.

The master key is stored in a local file on the SSO server machine, and its confidentiality is protected by an Access Control List (ACL) for that file. The ACL limits access to the root (for the UNIX® operating system) or Administrator (for the Microsoft Windows NT® operating system) so that only the SSO server process (which runs as the root or the Administrator) can access the file. However, since the master key can be used to gain access to nearly every resource on the network, as a general security guideline, the master key must be modified periodically or whenever there is a suspicion that the master key has been compromised.

When the master key is changed, each one of the SSO target passwords must be decrypted with the old master key and encrypted with the new master key in a process that is called “rekeying”. The rekeying process is computationally expensive because encryption and decryption requires significant processor use and disk access.

The following analysis illustrates the computational load during the rekeying process for a typical SSO system. Rekeying requires the following steps:

1. The encrypted target passwords of all SSO users are retrieved from the SSO database.

2. Each single target password is decrypted with the current master key.

3. A new master key is generated.

4. Each single target password is encrypted with the new master key.

5. The targets of all SSO users are stored back to the SSO database.

Typically, the Data Encryption Standard (DES) system is used by the SSO server. A typical DES encryption or decryption takes approximately 2000 processor cycles, so a round-trip decryption and encryption of a target password requires 4000 processor cycles. If one assumes that there are approximately 1000 SSO users and each user has 10 target passwords, then a portion of the amount of computational time for the rekeying process would be:

(1000 users)*(10 passwords/user)*(4000 cycles/password)=40 million cycles.

It should be noted that significant amounts of additional time would be required to organize and to administrate the process, to access the database, and to retrieve and store all of the target passwords.

Therefore, it would be advantageous to provide a method and system for more efficiently rekeying target passwords within a single sign-on system.

### SUMMARY OF THE INVENTION

A method, system, apparatus, and computer program product are presented for significantly decreasing the computational effort for a rekeying process without sacrificing the security of a single sign-on system. For each user, a “minor” key is created when the user's account within the single sign-on system is created; the user's minor key and the master key are then used in combination to encrypt and decrypt the user's target passwords. However, to protect the confidentiality of a user's minor key, the minor key is not stored directly. Instead, a storage key is generated by masking a user's minor key with the master key in an appropriate manner, e.g., using the user's minor key and the master key as inputs to an exclusive-OR function to generate the storage key. A user's storage key can then be stored without compromising the user's minor key or the master key, and the user's minor key can be efficiently regenerated using the storage key and the master key. When a new target password is created, the master key is used to regenerate the user's minor key from the user's storage key, and the user's minor key is then used to encrypt and decrypt the new target password rather than directly using the master key.

However, the rekeying process, in which the previous master key is replaced with a new master key, is efficient across all of the users because only a single data item, a user's storage key, needs to be modified for each user. The modification is performed quickly and efficiently: the user's minor key is regenerated using the user's current storage key and the previous master key, and a new storage key for the user is generated from the user's minor key and the new master key. The user's new storage key is then stored in an appropriate manner.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2A is a diagram depicting software components within a typical single sign-on (SSO) server and a connected client;

FIG. 2B is a hierarchical diagram depicting the relationship between a master key and sets of target passwords in accordance with a known manner of using a master key to encrypt target passwords;

FIG. 2C is a block diagram depicting a SSO database that stores a master key along with user information associated with sets of target passwords;

FIG. 3A is a hierarchical diagram depicting the relationship of a master key, a set of minor keys, and sets of target passwords in accordance with a preferred embodiment of the present invention;

FIG. 3B is a block diagram depicting a SSO database that stores a master key along with user information for each user, including a user storage key associated with each user's set of target passwords, in accordance with a preferred embodiment of the present invention;

FIG. 4 is a flowchart depicting the process of establishing a data storage system including encoded minor keys in accordance with a preferred embodiment of the present invention;

FIG. 5 is a flowchart depicting the process of retrieving a target password stored within the SSO database in accordance with a preferred embodiment of the present invention;

FIG. 6 is a flowchart depicting the process of rekeying the master key in accordance with a preferred embodiment of the present invention; and

FIGS. 7A-7B are diagrams depicting the encoding and decoding of a minor key using a master key.

### DETAILED DESCRIPTION OF THE INVENTION

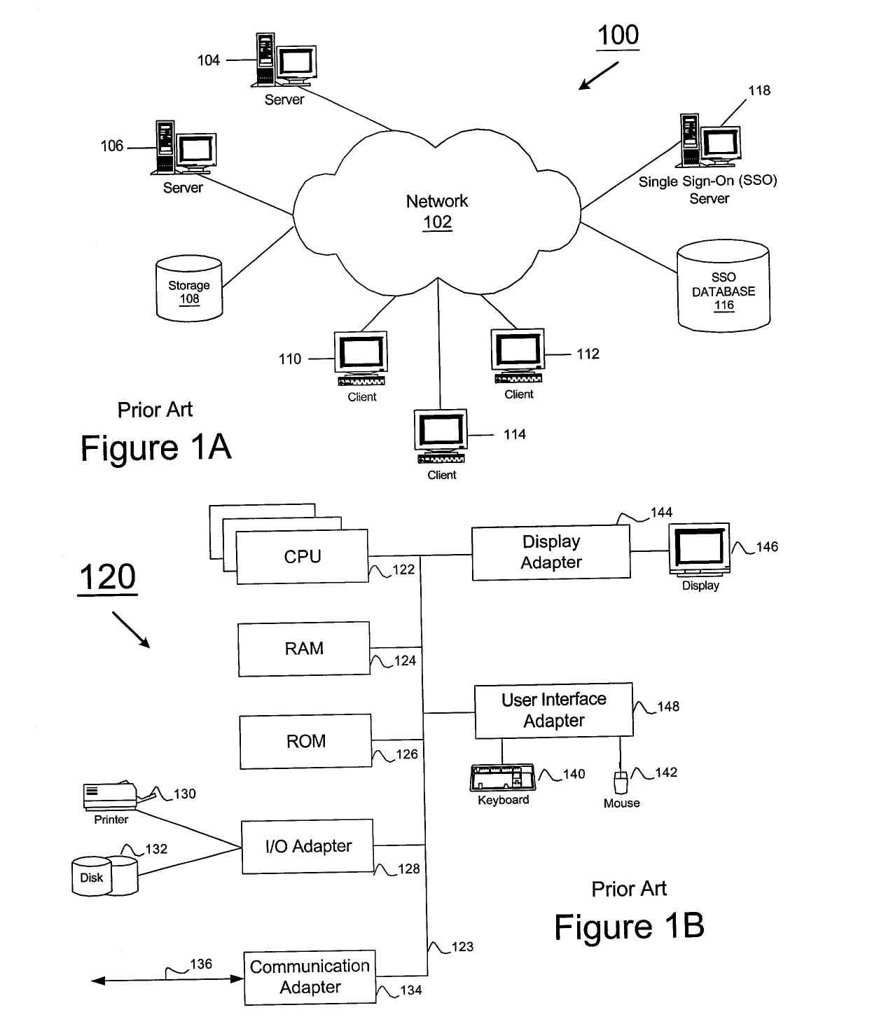

With reference now to the figures, FIG. 1A depicts a typical network of data processing systems. Distributed data processing system 100 contains network 102, which is a medium that may be used to provide communications links between various devices and computers connected together within distributed data processing system 100. Network 102 may include permanent connections, such as wire or fiber optic cables, or temporary connections made through telephone or wireless communications. In the depicted example, application server 104 and application server 106 are connected to network 102 along with storage unit 108. In addition, clients 110-114 also are connected to network 102. Clients 110-114 can employ single sign-on (SSO) server 116 and SSO database 118 to access restricted resources. To access restricted resources, a user must have credentials for each resource. Sign-on server 116 in conjunction with SSO database 118 to manage the authentication process; SSO database 118 may be driven by a database engine such as IBM DB2®, and SSO database 118 may or may not be a distributed database as necessary.

The present invention could be implemented on a variety of hardware platforms; FIG. 1A is intended as an example of a heterogeneous computing environment and not as an architectural limitation for the present invention. Data processing systems connected to the network may be represented by a variety of computing devices, such as mainframes, personal computers, personal digital assistants (PDAs), etc. Distributed data processing system 100 may include additional servers, clients, routers, and other devices that are not shown.

With reference now to FIG. 1B, a diagram depicts a typical computer architecture of a data processing system, such as those shown in FIG. 1A. Data processing system 120 contains one or more central processing units (CPUs) 122 connected to internal system bus 123, which interconnects random access memory (RAM) 124, read-only memory (ROM) 126, and input/output adapter 128, which a- supports various I/O devices, such as printer 130, disk units 132, or other devices not shown, such as a sound system, etc. System bus 123 also connects communication adapter 134 that provides access to communication link 136. Communication adapter 134 may include a network interface card (NIC). User interface adapter 148 connects various user devices, such as keyboard 140 and mouse 142, or other devices not shown, such as a stylus, microphone, etc. Display adapter 144 connects system bus 123 to display device 146.

Those of ordinary skill in the art will appreciate that the hardware in FIG. 1B may vary depending on the system implementation. For example, the system may have one or more processors and multiple types of non-volatile memory. Other peripheral devices may be used in addition to or in place of the hardware depicted in FIG. 1B. In other words, one of ordinary skill in the art would not expect to find similar components or architectures within a network-enabled phone and a desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a Microsoft® Windows® operating system environment.

The present invention may be implemented on a variety of hardware and software platforms, as described above. More specifically, though, the present invention is directed to providing an efficient methodology for managing target passwords for the users of a distributed computing system that employs single sign-on. While the figures describe an example in which target passwords are securely managed, it should be noted, however, that the present invention may be used to securely store and/or manage different types of data elements other than target passwords. In other words, the methodology of the present invention in using major and minor keys is applicable to the secure management of any type of data element.

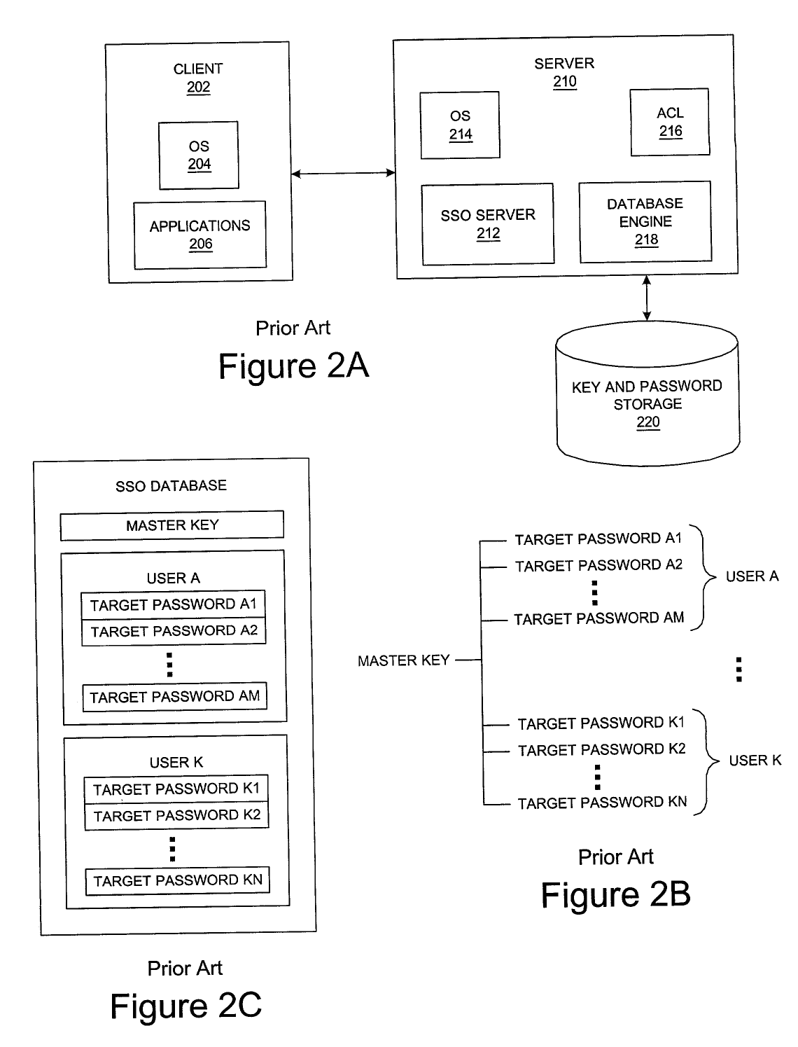

With reference now to FIG. 2A, a diagram depicts software components within a typical single sign-on (SSO) server and a connected client. Client 202 runs operating system 204 that supports the execution of applications 206. A user of client 202 may use one of the applications, which may attempt to access a restricted resource. In order to authenticate the user and to determine whether the user is authorized to access the restricted resource, SSO server component 212 executing on server 210 may be consulted. Client 202 and server 210 are similar to the clients and servers shown within FIGS. 1A-1B. Server 210 runs operating system 214, through which SSO server component 212 consults Access Control List (ACL) 216 associated with a particular resource to determine whether the user of the client application has authorization to the restricted resource. Database engine 218 may be used as necessary by the other components on server 210 to store and retrieve information within storage 220, such as keys and passwords.

An enterprise may have a distributed data processing system that is accessible by all employees of the enterprise. However, each user is only authorized to use a limited subset of resources within the computer system, and each resource may have its own authorization scheme that requires a unique username and associated password. Hence, each user of the distributed computing system may have a set of usernames and passwords for accessing restricted resources throughout the enterprise.

As noted previously, a single sign-on system can provide centralized password management for all the users in an enterprise. The passwords of all SSO users for various SSO targets, i.e. restricted resources, are stored/managed in a centralized SSO database. Preferably, this database is structured as a security registry according to the Open Software Foundation's (OSF) Distributed Computing Environment (DCE) standard. Since a DCE security registry does not provide any encryption facility for applications to protect the confidentiality of the data stored in the registry, the SSO server uses a master key to encrypt all of the target passwords before storing them in the SSO database. When the target passwords of a SSO user are retrieved by the SSO server at the request of a SSO client (running on behalf of the SSO user), the passwords will be decrypted with the same master key before being sent to the SSO client.

With reference now to FIG. 2B, a hierarchical diagram depicts the relationship between a master key and sets of target passwords in accordance with a known manner of using a master key to encrypt target passwords. Each user has a set of target passwords; the master key is used to encrypt and decrypt the target passwords when storing or retrieving the target passwords from the database.

With reference now to FIG. 2C, a block diagram depicts a SSO database that stores a master key along with user information associated with sets of target passwords. The master key is created when the SSO server is installed or configured. It should be noted that the master key is not necessarily stored within a file that contains target passwords. The master key is stored in a local file on the SSO server machine, and its confidentiality is protected by an Access Control List (ACL) for that file. The ACL limits access to the root (for the UNIX® operating system) or Administrator (for the Microsoft Windows NT® operating system) so that only the SSO server process (which runs as the root or the Administrator) can access the file.

When a new user needs access to the enterprise's computing system, a user account of some type is created, and user information for the new user is stored within the SSO database. When a user requires access to a specific target resource, the user is provided with a username or user identifier and password for that specific target resource, all of which can be stored within the SSO database in an appropriate manner.

As noted above, the SSO server uses the master key to encrypt each target password before storing it in the SSO database. When a target password is needed for comparison against the password entered by the user to gain access to a restricted resource, the master key is used to decrypt the target password. However, since the master key can be used to gain access to nearly every resource on the network, as a general security guideline, the master key must be modified periodically or whenever there is a suspicion that the master key has been compromised. During the rekeying process, all of the target passwords must be decrypted with the old master key and encrypted with the new master key, and the rekeying process can be very time-consuming. In order to provide a more efficient rekeying process, the present invention introduces the use of a minor key for each user.

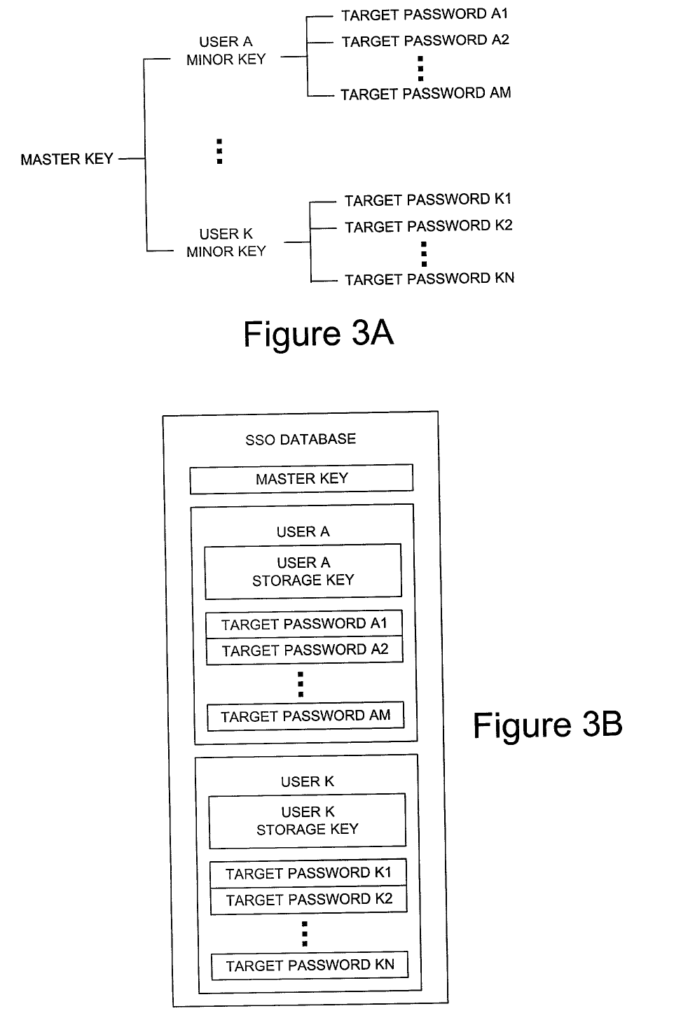

With reference now to FIG. 3A, a hierarchical diagram depicts the relationship of a master key, a set of minor keys, and sets of target passwords in accordance with a preferred embodiment of the present invention. When a user account is created within the SSO system for a new user, a minor key is created for the user, and the minor key must then be used to encrypt and decrypt the user's target passwords, as described in more detail further below. As shown in FIG. 3A, the minor key introduces another level of computation between a request to retrieve or store a target password into the SSO database; the master key is not directly applied to the target passwords.

With reference now to FIG. 3B, a block diagram depicts a SSO database that stores a master key along with user information for each user, including a user storage key associated with each user's set of target passwords, in accordance with a preferred embodiment of the present invention. In the present invention, the master key is still created when the SSO server is installed or configured. In a manner similar to that shown in FIG. 2C, when a new user needs access to the enterprise's computing system, a user account of some type is created, and user information for the new user is stored within the SSO database. When a user requires access to a specific target resource, the user is provided with a username or user identifier and password for that specific target resource, all of which can be stored within the SSO database in an appropriate manner.

However, in contrast to FIGS. 2B-2C, when a user's target password is stored or retrieved, it is encrypted or decrypted with the user's minor key, as described above with respect to FIG. 3A. In addition, rather than directly and insecurely storing the user's minor key, a storage key is generated; when storing and retrieving the user's minor key, the user's minor key is encoded and decoded to generate a storage key for the user, and the storage key is stored within the SSO database, as shown in FIG. 3B. The terms “storage key” and “encoded minor key” are thus interchangeable. Since the encoding function is quick and simple yet secure, very little computational effort is introduced when storing and retrieving a minor key.

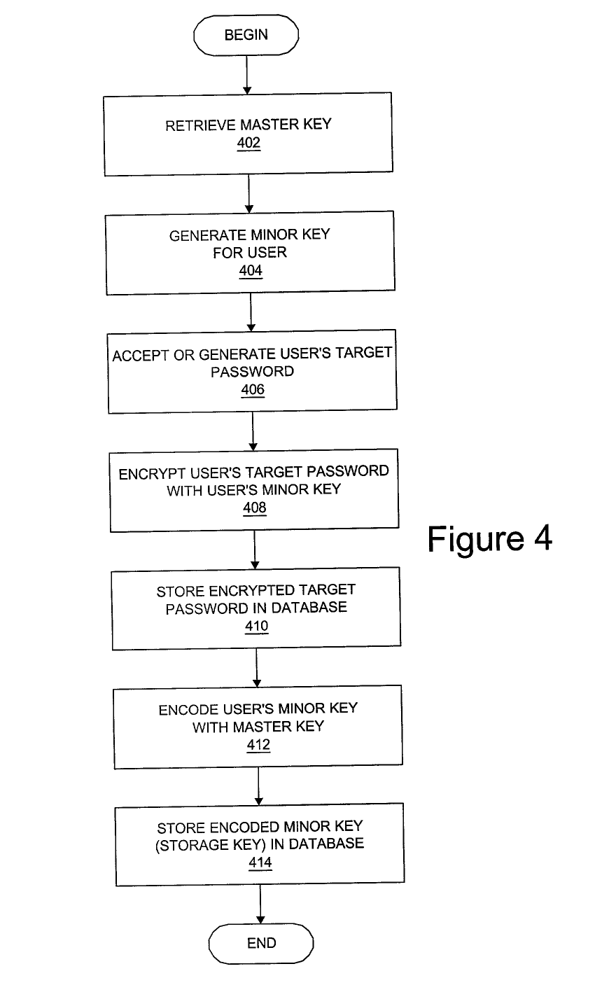

With reference now to FIG. 4, a flowchart depicts the process of establishing a data storage system including encoded minor keys in accordance with a preferred embodiment of the present invention. The process begins when a new user is being added to the system; the master key is first retrieved from the database (step 402). It may be assumed that the SSO server has already been installed and configured to generate and store a master key.

A minor key is generated for the new user (step 404), and assuming that the user is also being provided with access to at least one restricted target resource, the user's target password is accepted or generated (step 406) and then encrypted with the user's minor key (step 408). The encrypted target password is then stored within the database (step 410) for use at a later time when the user actually attempts to access the restricted target resource.

In order to keep the user's minor key confidentially and securely stored, the user's minor key is encoded with the master key (step 412) in order to generate an encoded minor key, i.e. the user's storage key. The storage key is then stored within the database (step 414), and the process of configuring an encrypted target password with an associated minor key is complete.

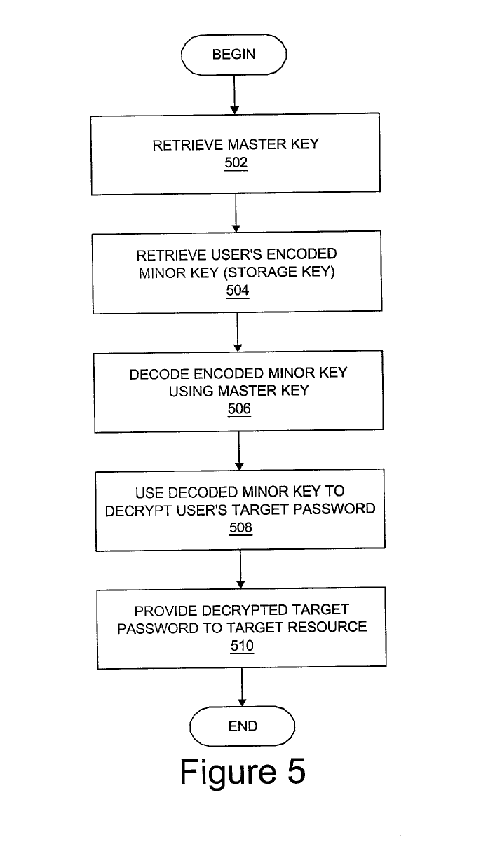

With reference now to FIG. 5, a flowchart depicts the process of retrieving a target password stored within the SSO database in accordance with a preferred embodiment of the present invention. The process begins by retrieving the master key (step 502) and retrieving the user's encoded minor key, i.e. the user's storage key (step 504). The master key is used to decode the encoded minor key in order to regenerate the minor key (step 506). The decoded minor key is used to decrypt the user's encrypted target password (step 508). The target password is then provided to the target resource to authorize the user for access to the target resource (step 510), and the process is complete.

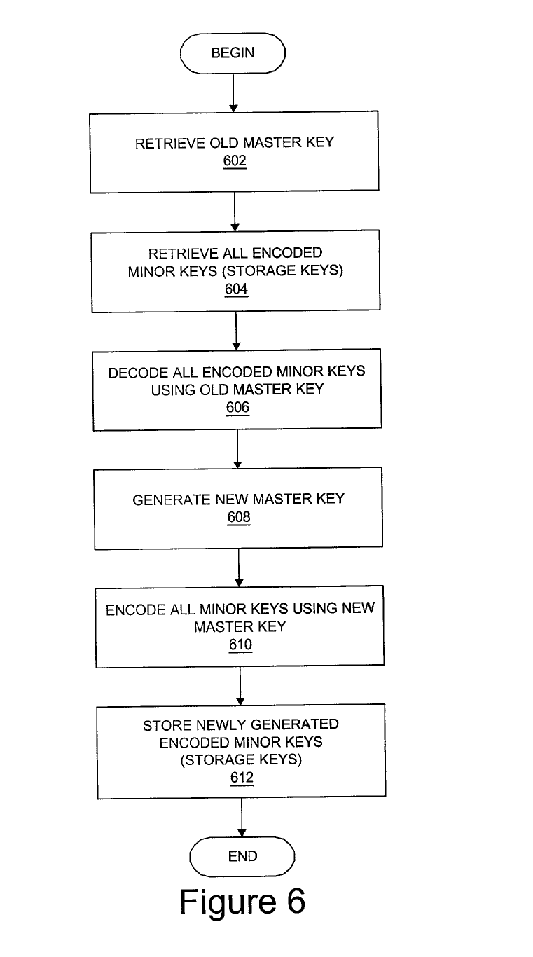

With reference now to FIG. 6, a flowchart depicts the process of rekeying the master key in accordance with a preferred embodiment of the present invention. The process begins by retrieving the old or previous master key (step 602) and retrieving all encoded minor keys, i.e. storage keys (step 604). All of the encoded minor keys are then decoded using the old master key (step 606). After generating a new master key (step 608), all of the minor keys are encoded using the new master key (step 610). Alternatively, the minor keys could be decoded and then encoded individually rather than as a group. The newly generated encoded minor keys, i.e. the newly generated storage keys, are then stored back into the database (step 612), and the process is complete.

The present invention is directed to an efficient process for managing target passwords, and the methodology of the present invention includes a rekeying process that is efficient because the number of data items that must be changed during the rekeying process has been significantly reduced in comparison to previously known methods. In particular, the present invention uses minor keys as an intermediate data item between the master key and the target passwords.

The minor keys must also be securely managed, so they are encoded and decoded when they are stored and retrieved. Many different encode/decode functions could be used on the minor keys, but the encode/decode function should also be selected to be as efficient as possible. In a preferred embodiment, a bitwise masking function is used with the master key and a minor key as inputs because bit operations are particularly quick and are readily available within almost all hardware processors or CPUs. In particular, an exclusive-OR function is used in which a minor key is exclusive-ORed against the master key during both the encoding and decoding process.

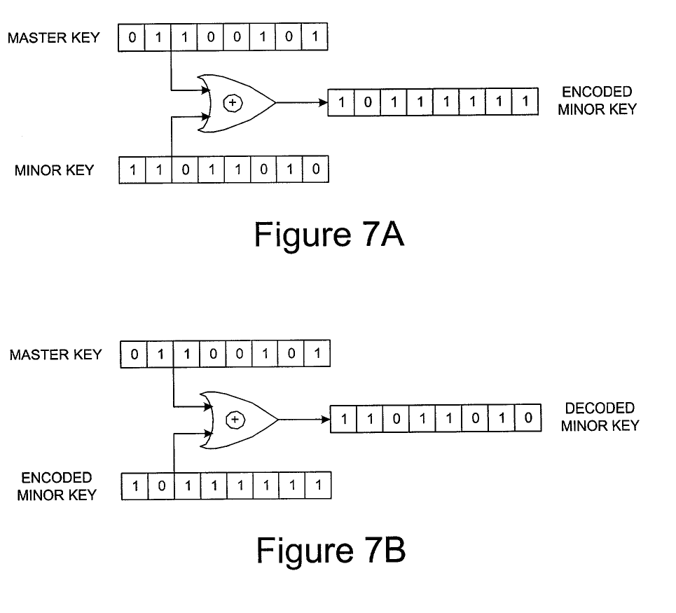

With reference now to FIGS. 7A-7B, two diagrams depict the encoding and decoding of a minor key using a master key. As shown in FIG. 7A, the present invention may use an exclusive-OR function in which the master key and a particular minor key are used as inputs to the function in order to generate an encoded minor key (or storage key) to be associated with the minor key. The encoded minor key may then be stored within the database without minimized concern for it being compromised. In reverse, as shown in FIG. 7B, the present invention may use an exclusive-OR function in which the master key and a particular encoded minor key are used as inputs to the exclusive-OR function in order to regenerate a minor key.

The advantages of the present invention should be apparent in view of the detailed description of the invention that is provided above. A rekeying process, in which a previous master key is replaced with a new master key, is efficient because only a single data item, a user's storage key, needs to be modified for each user. The modification is performed quickly and efficiently: the user's minor key is regenerated using the user's current storage key and the previous master key, and a new storage key for the user is generated from the user's minor key and the new master key.

The gains in efficiency can be illustrated by analyzing the reduced computational load during the new rekeying process for a typical SSO system. Assuming that the masking function for the minor key is an exclusive-OR function, the new rekeying process requires the following steps:

1. A new master key is generated.

2. Each user's minor key is obtained by exclusive-ORing the current master key and the user's current storage key.

3. The user's minor key is exclusive-ORed with the new master key to generate the user's new storage key.

Assuming that a typical exclusive-OR function takes approximately two processor cycles, a round-trip unmasking and masking of a user's storage key requires 4 processor cycles. If one assumes that there are approximately 1000 SSO users and each user has 10 target passwords, then a portion of the amount of computational time for the rekeying process would be:

(1000 users)*(1 minor key/user)*(4 cycles/minor key)=4000 cycles.

As shown, the new rekeying process requires only 4000 cycles instead of the 40,000,000 cycles that were required by the previous rekeying process. The dramatic improvement is caused primarily because the new process does not require DES decryption and encryption for each target password when the master key is changed. Only each user's minor key is decrypted with the old master key and re-encrypted with the new master key. It is actually each user's minor key, not the master key, that is used to protect the target passwords, and the minor key itself is protected by the master key. Therefore, when the master key is changed, only the user's storage key needs to be changed.

The new methodology leads to a significant performance improvement during the rekeying process. Additional time savings would be obtained if the additional time to retrieve and store all of the target passwords from/to the SSO database in the previous rekeying process were considered. Moreover, reliability is increased in the new rekeying process because the target passwords themselves are not modified during the new rekeying process. With the old rekeying process, if any errors occur during the procedure of storing the targets back to the SSO database, then the passwords might be lost.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for securing data elements within a database, the method comprising the steps of:
generating a minor key;
encrypting a data element using the minor key;
storing the encrypted data element in the database;
retrieving a master key;
encoding the minor key with the master key to generate an encoded minor key; and
storing the encoded minor key.

2. The method of claim 1 wherein the encoded minor key is generated in accordance with an encoding function that accepts the minor key and the master key as inputs to the encoding function.

3. The method of claim 2 wherein the encoding function is a bitwise operation against the minor key and the master key.

4. The method of claim 3 wherein the encoding function is an exclusive-OR function.

5. The method of claim 1 wherein the master key and the minor key are DES (Data Encryption Standard) keys.

6. The method of claim 1 wherein the encoded minor key is associatively stored with the encoded data element in the database.

7. The method of claim 1 wherein the data element is a password.

8. The method of claim 1 further comprising:
retrieving the master key;
retrieving the encoded minor key;
decoding the encoded minor key with the master key to regenerate the minor key;
retrieving the encrypted data element from the database; and
decrypting the encrypted data element using the minor key to regenerate the data element.

9. The method of claim 1 further comprising:
retrieving the master key;
retrieving the encoded minor key;
decoding the encoded minor key with the master key to regenerate the minor key;
generating a second master key;
encoding the minor key using the second master key to generate a second encoded minor key; and
storing the second encoded minor key.

10. The method of claim 9 wherein the second encoded minor key is associatively stored with the encoded data element in the database.

11. A method for securely managing target passwords, wherein the target passwords provide access to target resources within a data processing system, the method comprising the steps of:
generating a minor key for a user of the data processing system, wherein the user has a plurality of target passwords;
encrypting the plurality of target passwords using the minor key;
storing the plurality of encrypted target passwords in a database;
retrieving a master key;
encoding the minor key with the master key to generate an encoded minor key; and
storing the encoded minor key.

12. The method of claim 11 further comprising:
generating a minor key for each user of the data processing system; and
encoding the minor key for each user with the master key.

13. The method of claim 11 further comprising:
retrieving a set of target passwords associated with a second user, wherein each user of the data processing system has a set of target passwords; and
encrypting the set of target passwords using the minor key of the second user.

14. The method of claim 11 further comprising:
retrieving the master key;
retrieving the encoded minor key;
decoding the encoded minor key with the master key to regenerate the minor key;
retrieving an encrypted target password from the database; and
decrypting the encrypted target password using the minor key to regenerate the target password.

15. The method of claim 11 further comprising:
retrieving the master key;
retrieving the encoded minor key;
decoding the encoded minor key with the master key to regenerate the minor key;
generating a second master key;
encoding the minor key using the second master key to generate a second encoded minor key; and
storing the second encoded minor key.

16. A computer program product in a computer-readable medium for use in a data processing system for securing data elements within a database, the computer program product comprising:
instructions for generating a minor key;
instructions for encrypting a data element using the minor key;
instructions for storing the encrypted data element in the database;
instructions for retrieving a master key;
instructions for encoding the minor key with the master key to generate an encoded minor key; and
instructions for storing the encoded minor key.

17. The computer program product of claim 16 further comprising:
instructions for generating the encoded minor key in accordance with an encoding function that accepts the minor key and the master key as inputs to the encoding function.

18. The computer program product of claim 17 wherein the encoding function is a bitwise operation against the minor key and the master key.

19. The computer program product of claim 18 wherein the encoding function is an exclusive-OR function.

20. The computer program product of claim 16 wherein the master key and the minor key are DES (Data Encryption Standard) keys.

21. The computer program product of claim 16 further comprising:
instructions for associatively storing the encoded minor key with the encoded data element in the database.

22. The computer program product of claim 16 wherein the data element is a password.

23. The computer program product of claim 16 further comprising:
instructions for retrieving the master key;
instructions for retrieving the encoded minor key;
instructions for decoding the encoded minor key with the master key to regenerate the minor key;
instructions for retrieving the encrypted data element from the database; and
instructions for decrypting the encrypted data element using the minor key to regenerate the data element.

24. The computer program product of claim 16 further comprising:
instructions for retrieving the master key;
instructions for retrieving the encoded minor key;
instructions for decoding the encoded minor key with the master key to regenerate the minor key;
instructions for generating a second master key;
instructions for encoding the minor key using the second master key to generate a second encoded minor key; and
instructions for storing the second encoded minor key.

25. The computer program product of claim 24 further comprising:
instructions for associatively storing the second encoded minor key with the encoded data element in the database.

26. A computer program product in a computer-readable medium for use in a data processing system for securely managing target passwords, wherein the target passwords provide access to target resources within the data processing system, the computer program product comprising:
instructions for generating a minor key for a user of the data processing system, wherein the user has a plurality of target passwords;
instructions for encrypting the plurality of target passwords using the minor key;
instructions for storing the plurality of encrypted target passwords in a database;
instructions for retrieving a master key;
instructions for encoding the minor key with the master key to generate an encoded minor key; and
instructions for storing the encoded minor key.

27. The computer program product of claim 26 further comprising:
instructions for generating a minor key for each user of the data processing system; and
instructions for encoding the minor key for each user with the master key.

28. The computer program product of claim 26 further comprising:
instructions for retrieving a set of target passwords associated with a second user, wherein each user of the data processing system has a set of target passwords; and
instructions for encrypting the set of target passwords using the minor key of the second user.

29. The computer program product of claim 26 further comprising:
instructions for retrieving the master key;
instructions for retrieving the encoded minor key;
instructions for decoding the encoded minor key with the master key to regenerate the minor key;
instructions for retrieving an encrypted target password from the database; and
instructions for decrypting the encrypted target password using the minor key to regenerate the target password.

30. The computer program product of claim 26 further comprising:
instructions for retrieving the master key;
instructions for retrieving the encoded minor key;
instructions for decoding the encoded minor key with the master key to regenerate the minor key;
instructions for generating a second master key;
instructions for encoding the minor key using the second master key to generate a second encoded minor key; and
instructions for storing the second encoded minor key.

31. An apparatus for securing data elements within a database, the apparatus comprising:
generating means for generating a minor key;
encrypting means for encrypting a data element using the minor key;
first storing means for storing the encrypted data element in the database;
retrieving means for retrieving a master key;
encoding means for encoding the minor key with the master key to generate an encoded minor key; and
second storing means for storing the encoded minor key.

32. An apparatus for securely managing target passwords, wherein the target passwords provide access to target resources within a data processing system, the apparatus comprising:
generating means for generating a minor key for a user of the data processing system, wherein the user has a plurality of target passwords;
encrypting means for encrypting the plurality of target passwords using the minor key;
first storing means for storing the plurality of encrypted target passwords in a database;
retrieving means for retrieving a master key;
encoding means for encoding the minor key with the master key to generate an encoded minor key; and
second storing means for storing the encoded minor key.
